(19) United States
(12) Patent Application Publication
(10) Pub. No.: US 2002/0147784 A1
(43) Pub. Date: Oct. 10, 2002

(54) User account handling on aggregated group of multiple headless computer entities

(76) Inventors: Stephen Gold, Bristol (GB); Peter Thomas Camble, Bristol (GB)

Correspondence Address: LOWE HAUPTMAN GILMAN & BERNER, LLP, Suite 310, 1700 Diagonal Road, Alexandria, VA, 22314, US

(21) Appl. No.: 09/827,362

(22) Filed: Apr. 6, 2001

(51) Int. Cl. G06F 15/16; G06F 15/173

(52) U.S. Cl. 709/208; 709/201; 709/223; 709/224

(57) ABSTRACT

A group of headless computer entities is formed via a local area network connection by means of an aggregation service application, operated on a headless computer entity selected as a master entity, which propagates configuration settings for time zone, application settings, security settings and the like across individual slave computer entities within the group. A human operator can change configuration settings globally at group level via a user interface display on a conventional computer having a user console, which interacts with the master headless computer entity via a web administration interface. Addition and subtraction of computer entities from a group are handled by an aggregation service application, and interlocks and error checking is applied throughout the group to ensure that no changes to a slave computer entity are made, unless those changes conform to global configuration settings enforced by the master headless computer entity.

### FIELD OF THE INVENTION

The present invention relates to the field of computers, and particularly although not exclusively to the handling of accounts between a plurality of computer entities.

### BACKGROUND TO THE INVENTION

It is know to aggregate a plurality of conventional computer entities, each comprising a processor, a memory, a data storage device, and a user console comprising a video monitor, keyboard and pointing device, e.g. mouse, to create a “cluster” in which the plurality of computer entities can be managed as a single unit, and viewed as a single data processing facility. In the conventional cluster arrangement, the computers are linked by high-speed data interfaces, so that the plurality of computer entities share an operating system and one or more application programs. This allows scalability of data processing capacity compared to a single computer entity.

True clustering, where all the processor capacity, memory capacity and hard disk capacity are shared between computer entities requires a high bandwidth link between the plurality of computer entities, which adds extra hardware, and therefore adds extra cost. Also there is an inherent reduction in reliability, compared to a single computer entity, which must then be rectified by adding more complexity to the management of the cluster,

Referring to FIG. 1 herein, there is illustrated schematically a basic architecture of a prior art cluster of computer entities, in which all data storage 100 is centralized, and a plurality of processors 101-109 linked together by a high-speed interface 110 operate collectively to provide data processing power to an application, and accessing a centralized data storage device 100. This arrangement is highly scalable, and more data processing nodes and more data storage capacity can be added.

However, problems with the prior art clustering architecture include:

A large amount of data traffic passes between the data processing nodes 100-109 in order to allow the plurality of data processor nodes to operate as a single processing unit.

The architecture is technically difficult to implement, requiring a high-speed bus between data processing nodes, and between the data storage facility.

Relatively high cost per data processing node.

Another known type of computer entity is a “headless” computer entity, also known as a “headless appliance”. Headless computer entities differ from conventional computer entities, in that they do not have a video monitor, keyboard or tactile device e.g. mouse, and therefore do not allow direct human intervention. Headless computer entities have an advantage of relatively lower cost due to the absence of monitor, keyboard and mouse devices, and are conventionally found in applications such as network attached storage devices (NAS).

The problem of how to aggregate a plurality of headless computer entities to achieve scalability, uniformity of configuration and automated handling of user accounts across a plurality of aggregated headless computer entities remains unsolved in the prior art.

In the case of a plurality of computer entities, each having a separate management interface, the setting of any “policy” type of administration is a slow process, since the same policy management changes would need to be made separately to each computer entity. This manual scheme of administering each computer entity separately also introduces the possibility of human error, where one or more computer entities may have different policy settings to the rest.

Another issue, is that installing new users onto a set of separate computer entities requires a lot of administration, since the administrator has to allocate computer entity data processing and/or data storage capacity carefully, so that each individual user is assigned to a specific computer entity.

Specific implementations according to the present invention aim to overcome these technical problems particularly but not exclusively in relation to headless computer entities, in order to provide an aggregation of computer entities giving a robust, scaleable computing platform, which, to a user acts as a seamless, homogenous computing resource, but without incurring the technical complexity of prior art cluster techniques.

### SUMMARY OF THE INVENTION

One object of specific implementations of the present invention is to form an aggregation of a plurality of headless computer entities into a single group to provide a single point of management of user accounts,

Another object of specific implementations of the present invention is, having formed an aggregation of headless computer entities, to provide a single point of agent installation into the aggregation.

Another object of specific implementation of the present invention is to synchronise application settings as between a plurality of separate applications installed on each of a plurality of aggregated computer entities.

In the best mode, each computer entity in the group is capable of providing an application functionality from an application program loaded locally onto the computer, with equivalent functionality being provided from any computer in the group, and all the applications locally stored, being set up in a common format.

A further object of specific implementation of the present invention is to implement automatic migration of user accounts from one computer entity to another in an aggregated group, to provide distribution of user accounts across computer entities in the aggregation in a manner which efficiently utilises capacity of computer entities, and levels demands on capacity across computer entities in the group.

Specific implementations according to the present invention create a group of computer entities, which causes multiple computer entities to behave like a single logical entity. Consequently, when implementing policy settings across all the plurality of computer entities in a group, an administrator only has to change the policy settings once at a group level. When new computer users are installed into the computer entity group, the group automatically balances these new users across the group without the human administrator having to individually allocate each user to a specific headless computer entity.

In the case of a system having a back-up computer entity for providing back-up data storage to a plurality of client computers, each clients back-up account is stored on a single computer entity, and this includes sharing common back-up data between accounts on that computer entity. In a best mode, an SQL database on the computer entity is used to keep track of the account data. This architecture means that the computer entities cannot be simply “clustered” together into a single logical entity. This means distributing the SQL database across all the computer entities in the group, and creating a distributive network file system for the data volumes across the computer entity group. This would be very difficult to implement, and it would mean that if one computer entity in the group failed, then the entire computer entity group would go off line.

Consequently, specific implementations provide a group scheme for connecting a plurality of computer entities, where each computer entity in the group acts as a stand alone computer entity, but where policy settings for the computer entity group can be set in a single operation at group level.

New accounts are automatically “account balanced” so that they are created in a computer entity with the most available data storage capacity. This can be implemented without having to “cluster” the computer entity applications, databases and data, and may have the advantage that if one computer entity in a group fails, then the accounts of other computer entities in the group are still fully.

According to a first aspect of the present invention there is provided a system comprising a plurality of computer entities connected logically into a group in which:

a said computer entity is designated as a master computer entity;

at least one of said computer entities is designated as a slave computer entity; and

said slave computer entity comprises an agent component for allocating functionality provided by said slave computer entity to one or more external computer entities served by said group of computer entities, wherein said agent component operates to automatically allocate said slave computer functionality by:

creating a plurality of user accounts, each said user account providing an amount of computing functionality to an authorised user;

selecting a said slave computer entity and allocating said user account to said slave computer entity; and

allocating to each said user account an amount of computing functionality provided by a said slave computer entity.

According to a second aspect of the present invention there is provided an account balancing method for selecting a server computer entity for installation of a new user account to supply functionality to a client computer entity, said method comprising the steps of:

identifying at least one said server computer entity capable of providing functionality to said client computer entity;

performing at least one test to check that said identified server computer entity is suitable for providing functionality to said client computer entity;

if said server computer entity is suitable for providing said functionality, then opening a user account with said selected server computer entity, said user account assigning said functionality to said client computer entity.

According to a third aspect of the present invention there is provided a method of allocation of functionality provided by a plurality of grouped computer entities to a plurality of client computer entities, wherein each said client computer entity is provided with at least one account on one of said grouped computer entities, said method comprising the steps of:

determining a sub-network address of a client computer for which an account is to be provided by at least one said computer entity of said group;

selecting individual computer entities from said group, having a same subs network address as said client computer; and

opening an account for said client computer on a said selected computer entity having a same sub-network address.

According to a fourth aspect of the present invention there is provided a plurality of computer entities configured into a group, said plurality of computer entities comprising:

at least one master computer entity controlling configuration of all computer entities within said group;

a plurality of slave computer entities, which have configuration settings controllable by said master computer entity;

an aggregation service application, said aggregation service application configured to receive application settings from at least one application program, and distribute said application configuration settings across all computer entities within said group for at least one application resident on said group.

According to a fifth aspect of the present invention there is provided a method of configuring a plurality of applications programs deployed across a plurality of computer entities configured into a group of computer entities, such that all said application programs of the same type are sychronized to be configured with the same set of application program settings, said method comprising the steps of:

generating a master set of application configuration settings;

converting said set of master application configuration settings to a form which are transportable over a local area network connection connecting said group of computer entities;

receiving said master application configuration settings at a client computer of said group; and

applying said master application configuration settings to a client application resident on said client computer within said group.

According to a fifth aspect of the present there is provided a computer device comprising:

at least one data processor;

at least one data storage device capable of storing an applications program;

an operating system;

a user application capable of synchronizing to a common set of application configuration settings;

an aggregation service application, capable of interfacing with said user application, for transmission of said user application configuration settings between said user application and said aggregation service application.

According to a sixth aspect of the present invention as provided a method of aggregation of a plurality of computer entities, by deployment of an agent component, said agent component comprising:

a user application;

an aggregation service application;

said method comprising the steps of: loading a plurality of application configuration settings into said user application within said agent;

defining a sub-group of computer entities to be created by said agent and loading data defining said sub-group into said agent;

sending said agent component to a plurality of target computer entities of said plurality of computer entities;

within each said target computer entity, said agent installing said user application and said aggregation of service application, and deploying said application configuration settings within said target computer entity.

According to a seventh aspect of the present invention as provided a method for transfer of user accounts between a plurality of computer entities within a group of said computer entities, said method comprising the steps of:

monitoring a utilisation of each of a set of said computer entities within said group to locate a computer entity having a capacity which is utilised at above a pre-determined limit;

searching for a computer entity within said set which has a capacity utilisation below a second pre-determined limit;

selecting at least 1 user account located on said computer entity having said utilised capacity above said first pre-determined limit;

transferring said at least one selected user account from said computer entity having capacity utilisation above said first pre-determined limit to said selected found computer entity having utilisation below said second predetermined limit.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a prior art cluster arrangement of conventional computer entities, having user consoles allowing operator access at each of a plurality of data processing nodes;

FIG. 2 illustrates schematically a plurality of headless computer entities connected by a local area network, and having a single computer entity having a user console with video monitor, keyboard and tactile pointing device according to a specific implementation of the present invention;

FIG. 3 illustrates schematically in a perspective view, a headless computer entity;

FIG. 4 illustrates schematically physical and logical components of a headless computer entity comprising the aggregation of FIG. 2;

FIG. 5 illustrates schematically a logical partitioning structure of the headless computer entity of FIG. 4;

FIG. 6 illustrates schematically how a plurality of headless computer entities are connected together in an aggregation;

FIG. 7 illustrates schematically a logical layout of an aggregation service provided by an aggregation service application loaded on to the plurality of headless computer entities within a group;

FIG. 8 illustrates schematically a user interface at an administration console, for applying configuration settings to a plurality of headless computer entities at group level;

FIG. 9 illustrates schematically different possible groupings of computer entities within a network environment;

FIG. 10 illustrates schematically actions taken by an aggregation service application when a new computer entity is added to a group;

FIG. 11 illustrates schematically actions taken by a user application when application configuration settings are deployed across a plurality of computer entities within a group;

FIG. 12 sets out a set of operations carried out by agents at a plurality of client computer entities in an aggregation of computer entities;

FIG. 13 lists a set of operations which can be carried out for group administration by a human administrator via the administration console;

FIG. 14 lists operations which can be carried out using a web administration user interface on the master and/or slave computer entities;

FIG. 15 illustrates schematically processed steps carried out for creation of a sub-group of computers within a customer computer environment, by download of an agent to a customers computer network, for creation of a sub-group within a customer environment where each computer entity has a user application, having synchronised settings to other user applications of other computers within the sub-group;

FIG. 16 illustrates schematically processed steps carried out by an executable agent installation programme for initiating installation of an agent onto a computer entity;

FIG. 17 illustrates schematically a network of a plurality of computer entities, illustrating targeting of computer entities for forming groups and sub-groups within a network;

FIG. 18 illustrates schematically process steps carried out by an account balancing algorithm process for distributing a plurality of user accounts across computer entities within a group or subgroup;

FIG. 19 illustrates schematically process steps carried out to identify which individual computer entities within the group constitute valid targets to hold a new user account; and

FIG. 20 illustrates schematically process steps carried out for migration of user accounts from full or nearly full computer entities within a group onto computer entities having less than fully utilised capacity, for example computer entities newly added into the group.

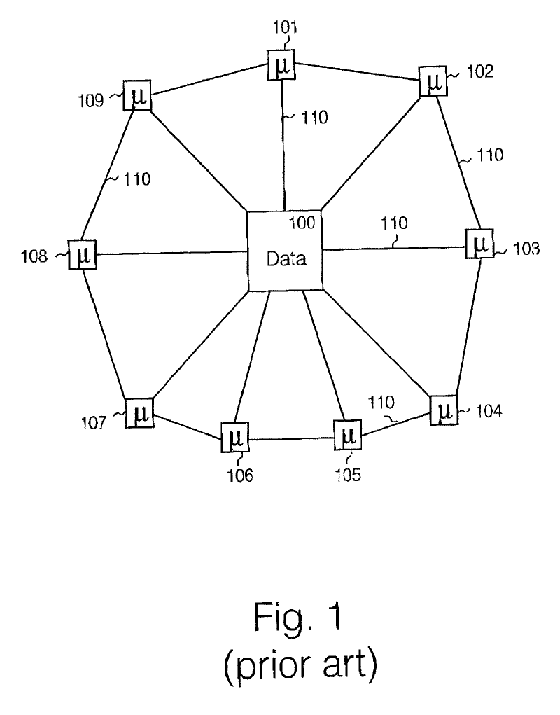

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

The best mode implementation is aimed at achieving scalability of computing power and data storage capacity over a plurality of headless computer entities, but without incurring the technical complexity and higher costs of prior art clustering technology. The specific implementation described herein takes an approach to scalability of connecting together a plurality of computer entities and logically grouping them together by a set of common configuration settings synchronised between the computers.

Features which help to achieve this include:

Being able to set configuration settings, including for example policies, across all computer entities in a group from a single location;

Distributing policies across a plurality of computer entities, without the need for human user intervention via a user console;

Automatic allocation of a new user account to a computer entity within a group.

For example, if there are 10,000 users, using 10 computer entities each capable of handling 1,000 users, the need for a human operator to individually assign each user to a specified computer entity needs to be avoided, and taken care of automatically.

Therefore, a feature of the specific implementation is automatic allocation of a user to a particular computer entity in a group, so that an administrator can present the group of computer entities as a single logical entity from the user's point of view, for allocation of new user accounts.

Various mechanisms and safeguards detailed herein specifically apply to headless computer entities, where changing an application, networking, security or time zone settings on one computer entity must be reflected across an entire group of computer entities. Interlocks are implemented to prevent an administrator from changing any of these settings when it is not possible to inform other computer entities in the group of the change.

In this specification, the term “user account” is used to describe a package of functionality supplied to a client computer by an aggregation of computer entities as described herein. The client computer entity is not part of the aggregation. The functionality may be provided by any one of the aggregated computer entity within the aggregation group.

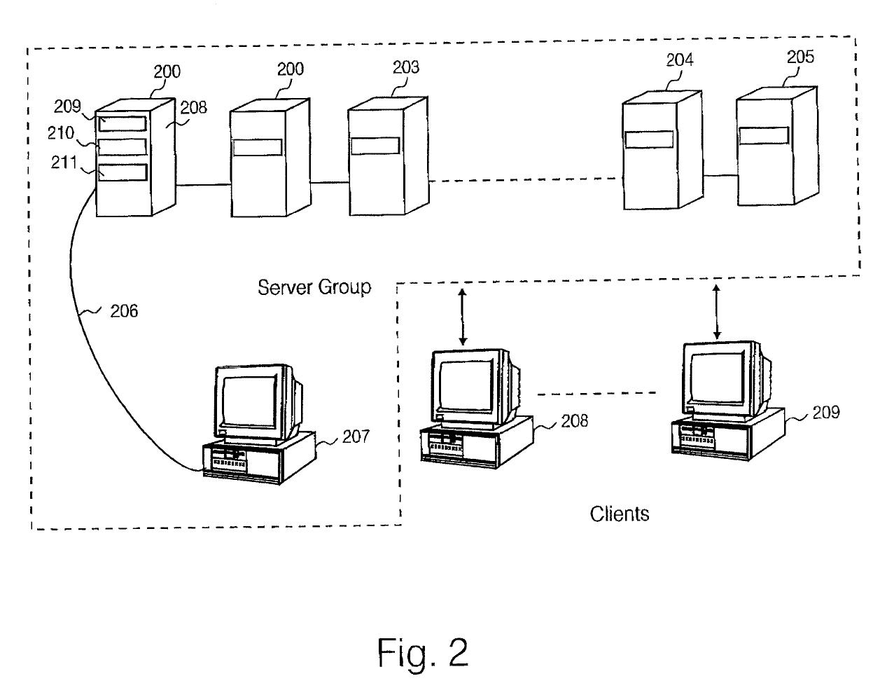

Referring to FIG. 2 herein, there is illustrated schematically an aggregation group of a plurality of headless computer entities according to a specific embodiment of the present invention. The aggregation comprises a plurality of headless computer entities 200-205 communicating with each other via a communications link, for example a known local area network 206; and a conventional computer entity 207, for example a personal computer or similar, having a user console comprising a video monitor, keyboard and pointing device, e.g. mouse and acting as a management console.

Each headless computer entity has its own operating system and applications, and is self maintaining. Each headless computer entity has a web administration interface, which a human administrator can access via a web browser on the management console computer 207. The administrator can set centralized policies from the management console, which are applied across all headless computer entities in a group.

Each headless computer entity may be configured to perform a specific computing task, for example as a network attached storage device (NAS). In general, in the aggregation group, a majority of the headless computer entities will be similarly configured, and provide the basic scalable functionality of the group, so that from a users point of view, using any one of that group of headless computer entities is equivalent to using any other computer entity of that group.

The aggregation group provides functionality to a plurality of client computers 208-209. Although in this specific embodiment the server functionality of bulk data storage is supplied by the aggregation group, in the broadest context of the invention, the functionality can be any computing functionality which can be served to a plurality of client computer entities, including but not limited to server applications, server email services or the like.

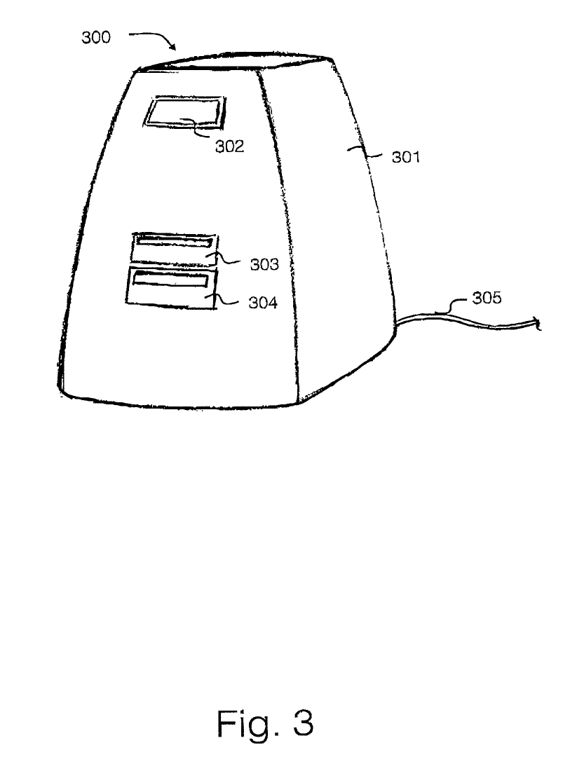

Referring to FIG. 3 herein, each headless computer entity of the group comprises a casing 301 containing a processor; memory; data storage device, e.g. hard disk drive; a communications port connectable to a local area network cable 305; a small display on the casing, for example a liquid crystal display (LCD) 302, giving limited information on the status of the device, for example power on/off or stand-by modes, or other modes of operation. Optionally a CD-ROM drive 303 and optionally a back-up tape storage device 304. Otherwise, the headless computer entity has no physical user interface, and is self-maintaining when in operation. Direct human intervention with the headless computer entity is restricted by the lack of physical user interface. In operation, the headless computer entity is self-managing and self-maintaining.

Each of the plurality of headless computer entities are designated either as a “master” computer entity, or a “slave” computer entity. The master computer entity, controls aggregation of all computer entities within the group, and acts a centralized reference, for determining which computer entities are in the group, and for distributing configuration settings including application configuration settings across all computer entities in the group, firstly to set up the group in the first place, and secondly, to maintain the group by monitoring each of the computer entities within the group and their status, and to ensure that all computer entities within the group continue to refer back to the master computer entity, to maintain the settings of those slave computer entities according to a format determined by the master computer entity.

Since setting up and maintenance of the group is at the level of maintaining configuration settings under control of the master computer entity, the group does not form a truly distributed computing platform, since each computer entity within the group effectively operates according to its own operating system and application, rather than in the prior art case of a cluster, where a single application can make use of a plurality of data processors over a plurality of computer entities using high speed data transfer between computer entities.

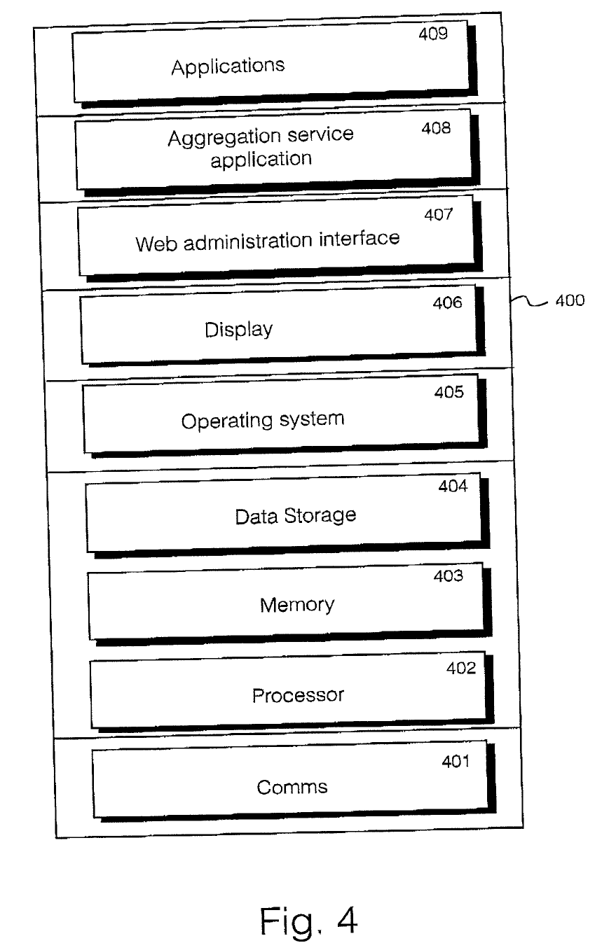

Referring to FIG. 4 herein, there is illustrated schematically physical and logical components of a headless computer entity 400. The computer entity comprises a communications interface 401, for example a local area network card such as an Ethernet card; a data processor 402, for example an Intel® Pentium or similar Processor; a memory 403, a data storage device 404, in the best mode herein an array of individual disk drives in a RAID (redundant array of inexpensive disks) configuration; an operating system 405, for example the known Windows 2000®, Windows95, Windows98, Unix, or Linux operating systems or the like; a display 406, such as an LCD display; an administration interface 407 by means of which information describing the status of the computer entity can be communicated to a remote display; a management module 408 for managing the data storage device 404; and one or a plurality of applications programs 409 which serve up the functionality provided by the computer entity.

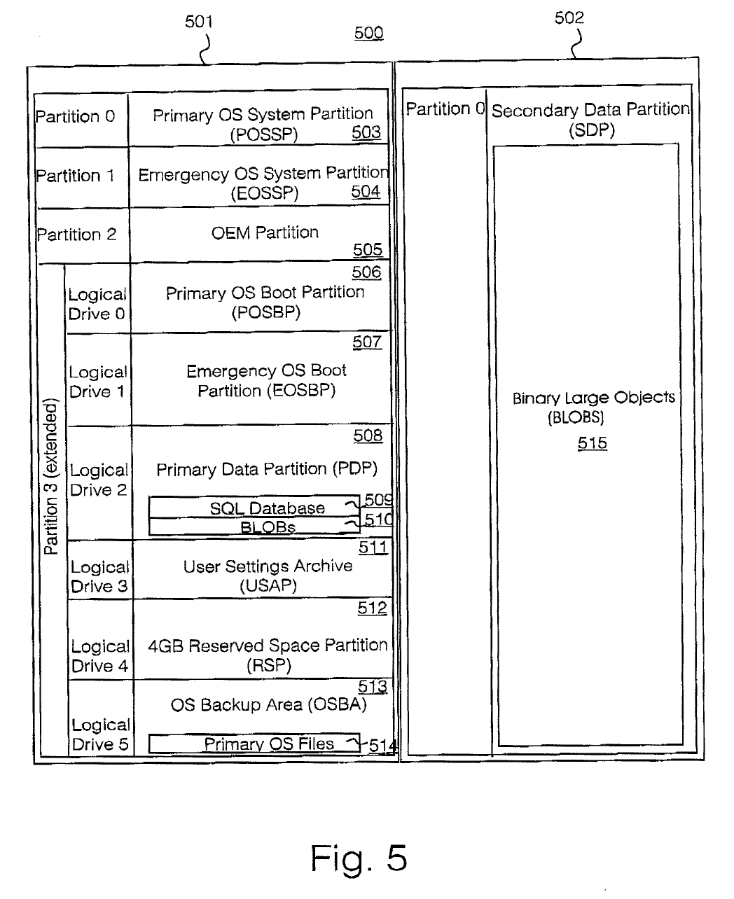

Referring to FIG. 5 herein, there is illustrated schematically a partition format of such a headless computer entity, upon which one or more operating system(s) are stored. Data storage device 404 is partitioned into a logical data storage area which is divided into a plurality of partitions and sub-partitions according to the architecture shown. A main division into a primary partition 500 and a secondary partition 501 is made. Within the primary partition are a plurality of sub partitions including a primary operating system system partition 502 (POSSP), containing a primary operating system of the computer entity; an emergency operating system partition 503 (EOSSP) containing an emergency operating system under which the computer entity operates under conditions where the primary operating system is inactive or is deactivated; an OEM partition 504; a primary operating system boot partition 505 (POSBP), from which the primary operating system is booted or rebooted; an emergency operating system boot partition 506 (EOSBP), from which the emergency operating system is booted; a primary data partition is 507 (PDP) containing an SQL database 508, and a plurality of binary large objects 509, (BLOBs); a user settings archive partition 510 (USAP); a reserved space partition 511 (RSP) typically having a capacity of the order of 4 gigabytes or more; and an operating system back up area 512 (OSBA) containing a back up copy of the primary operating system files 513. The secondary data partition 501 comprises a plurality of binary large objects 514.

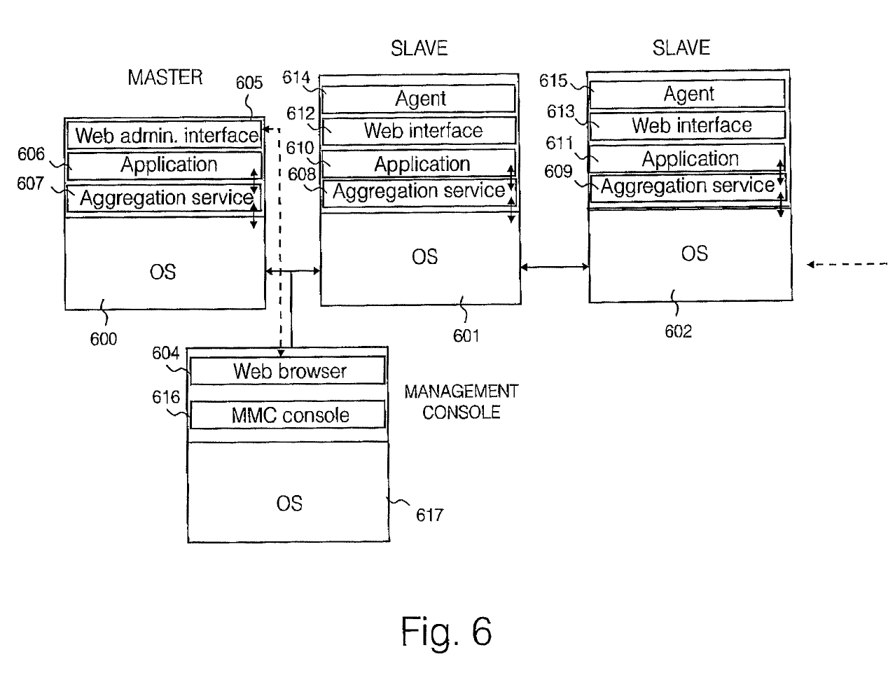

Referring to FIG. 6 herein, there is illustrated schematically interaction of a plurality of headless computer entities, and a management console in an aggregated group. The management console comprises a web browser 604 which can view a web administration interface 605 on a master headless computer entity. The web interface on the master headless computer entity is used for some group configuration settings, including time zone setting and security settings. Other main group administration function are provided by a Microsoft management console snap-in 616 provided on management console computer entity 617. Web interfaces 612, 613 are provided on each slave computer. The web administration interfaces on each computer entity are used to configure the computer entity level administration on those slave computer entities. On the mast computer entity, the web administration interface 615 on that computer controls security and time zone settings for the entire group. All user application group level configuration settings are made via the MMC console 616 on the management console 617.

The master headless computer entity comprises an aggregation service application 607, which is a utility application for creating and managing an aggregation group of headless computer entities. The human operator configures a master user application 606 on the management console computer entity via the web administration interface 605 and web browser 604. Having configured the user application 606 on the master computer entity, via the management console, the aggregation service master application 607 keeps record of and applies those configuration settings across all slave headless computer entities 601, 602.

Each slave headless computer entity, 601, 602 is loaded with a same aggregation service slave module 608, 609 and a same slave user application 610, 611. Modifications to the configuration of the first application 606 of the master computer entity are automatically propagated by the aggregation service application 607 to all the slave applications 610, 611 on the slave computer entities.

The aggregation service application 607 on the master headless computer entity 600 automatically synchronizes all of its quality system settings to all of the slaves 601, 602.

Further, the master user application 606 on the master computer synchronises its application settings with each of the slave applications 610, 611 on the slave computers. The master user application 606 applies it's sychronisation settings using the aggregation service provided by the aggregation service master and slave applications as a transmission platform for deployment of the user application settings between computer entities in the group.

From the users point of view, the group of headless computer entities acts like a single computing entity, but in reality, the group comprises individual member headless computer entities, each having its own processor, data storage, memory, and application, with synchronization and commonality of configuration settings between operations systems and applications being applied by the aggregation service 607, 608, 609.

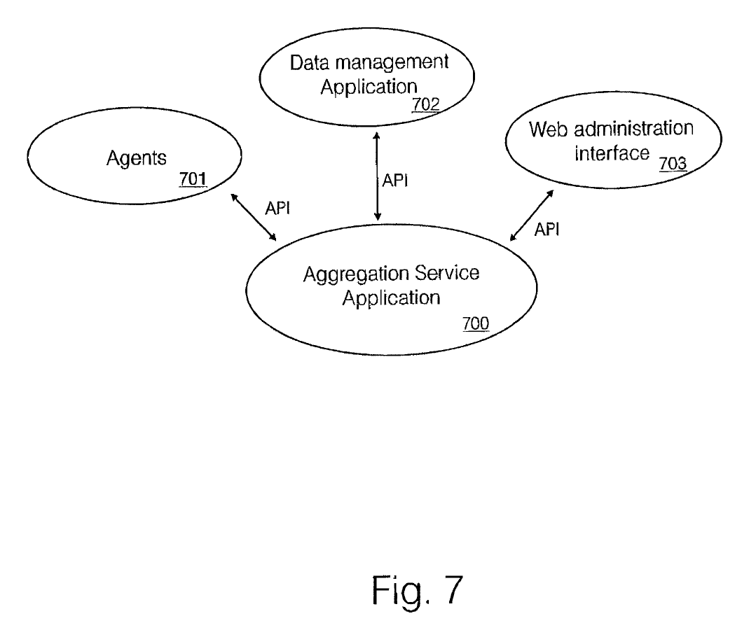

Referring to FIG. 7 herein, there is illustrated logically an aggregation service provided by an aggregation service application 700, along with modes of usage of that service by one or more agents 701, data management application 702, and by a human administrator via web administration interface 703. In each case, the aggregation service master responds via a set of API calls, which interfaces with the operating system on the master headless computer entity. Operations are then propagated from the operating system on the master computer entity, to the operating systems on each of the slave headless computer entities, which, via the slave aggregation service applications 608, 609, make changes to the relevant slave applications on each of the slave computer entities.

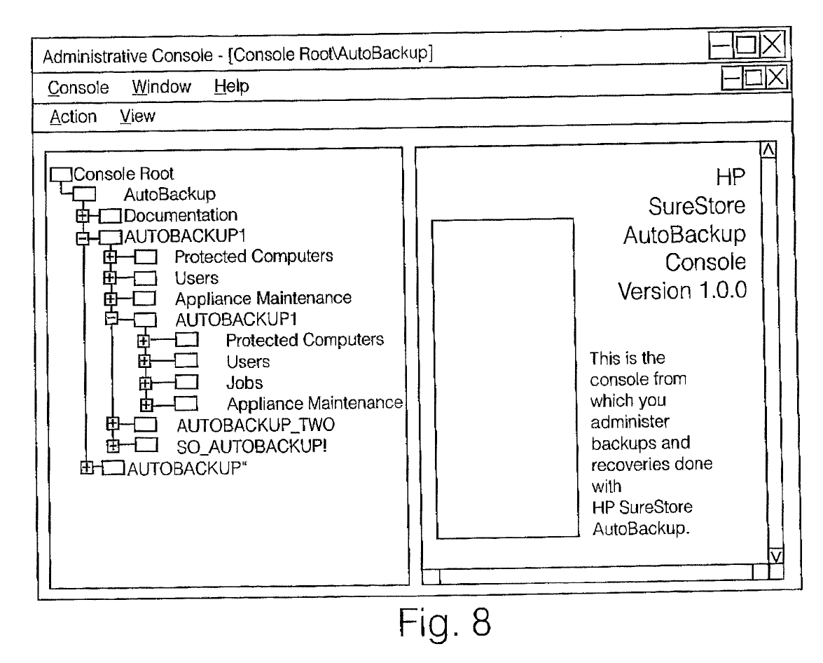

Referring to FIG. 8 herein, there is illustrated schematically a user interface displayed at the management console 207. The user interface is generated by the MMC console 616 resident on the management console 207. The user interface may be implemented as a Microsoft Management Console (MMC) snap-in.

The MMC interface is used to provide a single logical view of the computer entity group, and therefore allow application configuration changes at a group level. The MMC user interface is used to manage the master headless computer entity, which propagates changes to configuration settings amongst all slave computer entities. Interlocks and redirects ensure that configuration changes which affect a computer entity group are handled correctly, and apply to all headless computer entities within a group.

Limited user account management can be carried out from the management console as described hereafter. Addition and deletion of computer entities and aggregation of computer entities into a group can be achieved through the management console 207.

The user interface display illustrated in FIG. 8 shows a listing of a plurality of groups, in this case a first group Auto Back Up 1 comprising a first group of computer entities, and a second group Auto Back Up 2 comprising a second group of computer entities.

Within the first group Auto Back Up 1, objects representing individual slave computer entities appear in sub groups including a first sub group protected computers, a second sub group users, and a third sub group appliance maintenance.

Each separate group and sub group appears as a separate object within the listing of groups displayed.

In the MMC-based management console, a menu option create auto back up appliance group may be selected. This allows an administrator to create a computer entity group with the selected computer entity as the master. When creating the group, the administrator has the option to enable or disable an account balancing feature. The “account balancing” mode allows the administrator to provide the single agent set up URL or agent download which automatically balances new accounts across the group.

When a new computer group is created in this manner, the name of the group is the same as the name of the master computer entity. So, if the name of the master computer entity is changed, this changes the group name as well. The computer entity group hangs off the auto back up branch, in the same way as a computer entity, and contains the “protected computer” and “users” branches, which lists the computers and user account names from all the computer entities currently in the group, and also contains a group level “appliance maintenance” container which allows configuration of group level maintenance job schedules. There is also an indicator showing whether the group has the account balancing mode enabled or disabled.

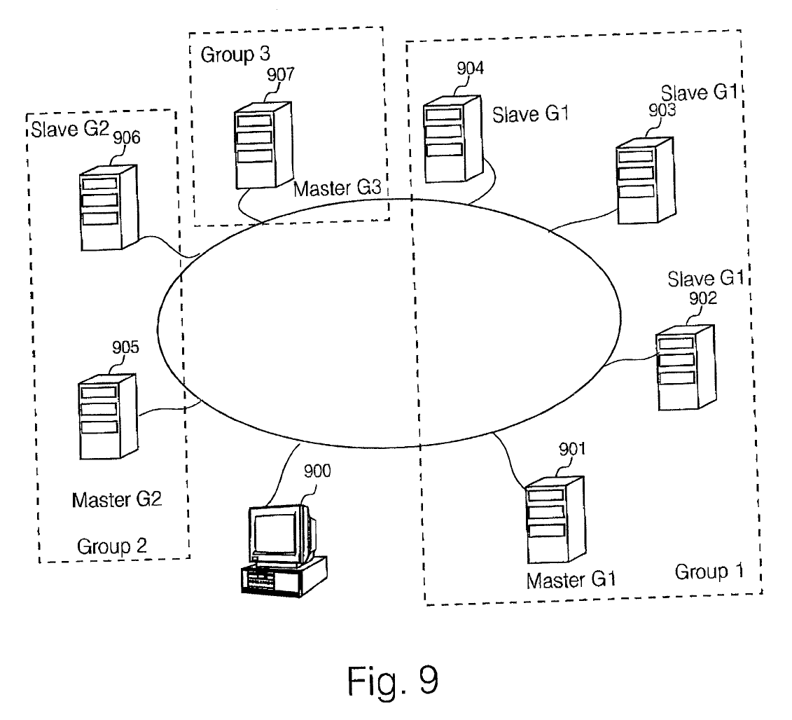

Referring to FIG. 9 herein, there is illustrated schematically an arrangement of networked headless computer entities, together with a management console computer entity 900. Within a network, several groups of computer entities each having a master computer entity, and optionally one or more slave computer entities can be created.

For example in the network of FIG. 9, a first group comprises first master 901, first slave 902 and second slave 903 and third slave 904. A second group comprises second master 905 and fourth slave 906. A third group comprises a third master 907.

In the case of the first group, the first master computer entity 901 configures the first to third slaves 902-904, together with the master computer entity 901 itself to comprise the first group. The first master computer entity is responsible for setting all configuration settings and application settings within the group to be self consistent, thereby defining the first group. The management console computer entity 900 can be used to search the network to find other computer entities to add to the group, or to remove computer entities from the first group.

Similarly, the second group comprises the second master computer entity 905, and the fourth slave computer entity 906. The second master computer entity is responsible for ensuring self consistency of configuration settings between the members of the second group, comprising the second master computer entity 905 and the fourth slave computer entity 906.

The third group, comprising a third master entity 907 alone, is also self defining. In the case of a group comprising one computer entity only, the computer entity is defined as a master computer entity, although no slaves exist. However, slaves can be later added to the group, in which case the master computer entity ensures that the configuration settings of any slaves added to the group are self consistent with each other.

In the simple case of FIG. 9, three individual groups each comprise three individual sets of computer entities, with no overlaps between groups. In the best mode herein, a single computer entity belongs only to one group, since the advantage of using the data processing and data storage capacity of a single computer entity is optimized by allocating the whole of that data processing capacity and data storage capacity to a single group. However, in other specific implementations and in general, a single computer entity may serve in two separate groups, to improve efficiency of capacity usage of the computer entity, provided that there is no conflict in the requirements made by each group in terms of application configuration settings, or operating system configuration settings.

For example in a first group, a slave entity may serve in the capacity of a network attached storage device. This entails setting configuration settings for a storage application resident on the slave computer entity to be controlled and regulated by a master computer entity mastering that group. However, the same slave computer entity may serve in a second group for a different application, for example a graphics processing application, controlled by a second master computer entity, where the settings of the graphics processing application are set by the second master computer entity.

In each group, the first appliance to use to create the group is designated as the “master”, and then “slave” computer entities are added to the group. The master entity in the group is used to store the group level configuration settings for the group, which the other slave computer entities synchronize themselves in order to be in the group.

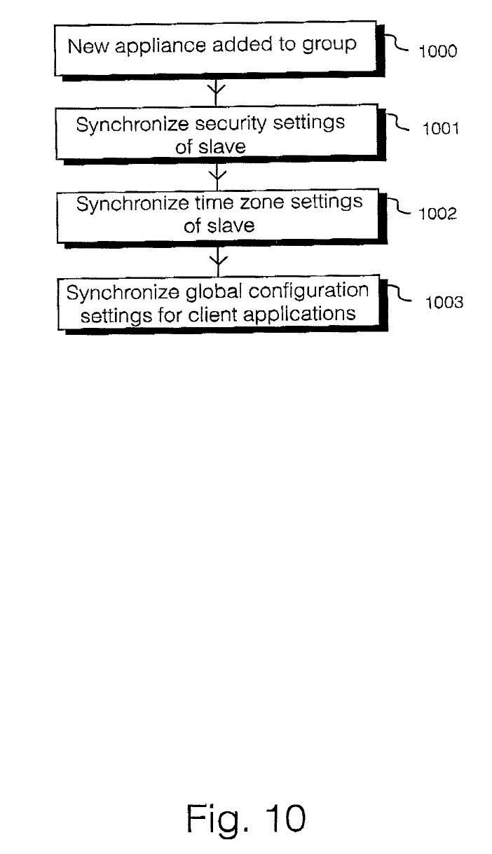

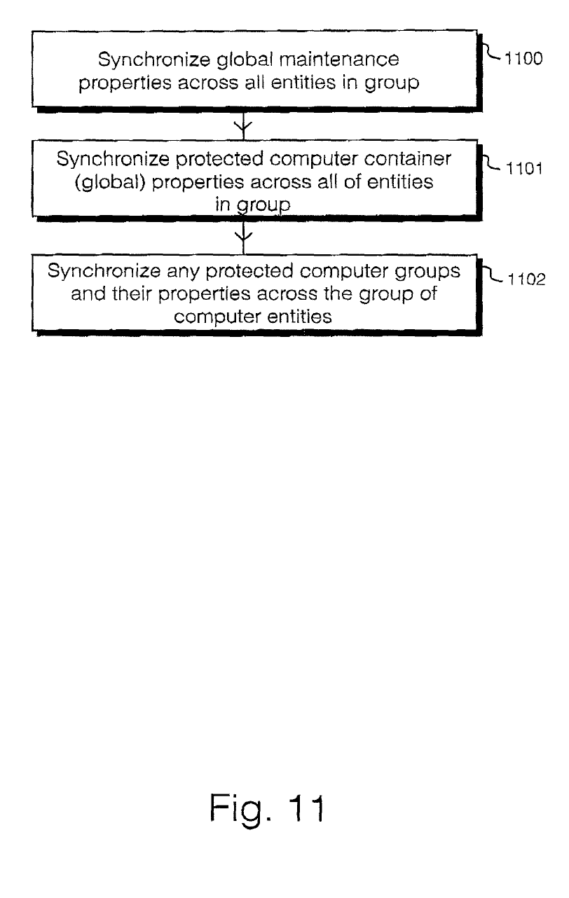

Referring to FIG. 10 herein, there is illustrated schematically actions taken by the aggregation service 607 when a new computer entity is successfully added to a group. The aggregation service 607 resident on the master computer entity 600 automatically synchronizes the security settings of each computer entity in the group in step 1001. This is achieved by sending a common set of security settings across the network, addressed to each slave entity within the group. When each slave entity receives those security settings, each slave computer entity self applies those security settings to itself. In step 1002, the aggregation service 607 synchronizes a set of time zone settings for the new appliance added to the group. Time zone settings will already exist on the master computer entity 600, (and on existing slave computer entities in the group). The time zone settings are sent to the new computer entity added to the group, which then applies those time zone settings on the slave aggregation service application in that slave computer entity, bringing the time zone settings of the newly added computer entity in line with those computer entities of the rest of the group. In step 1003, any global configuration settings for a common application in the group are sent to the client application on the newly added computer entity in the group. The newly added computer entity applies those global application configuration settings to the application running on that slave computer entity, bringing the settings of that client application, into line with the configuration settings of the server application and any other client applications within the rest of the group.

Referring to FIG. 11 herein, there is illustrated schematically actions taken by the master user application 606 to synchronize application settings across all computers in a group when a computer entity group is created. The actions are taken when a new computer entity group is created, by the application 605, 610, 611, which the group serves. The relevant commands need to be written into the master user application, in order that the master and slave user applications will run on the group of headless computer entities.

The ability to aggregate multiple computer entities into a single logical group can be used to simplify an advanced “policy” style management of multiple computer entities. If an administrator wants to set a common retention or exclusion or a quota policy across multiple computer entities in a group, when those appliances are aggregated into a group, they can perform global administration policies across all the computer entities in the group in a single operation.

The following group level policy configuration options are available via the MMN based console:

Change “protected computer group” properties—if any of the “schedule”. “retention”, “excludes”, “rights”, “log critical files”, “data file definition” or “limits and quotas settings” are changed from the “properties” menu of a group level “protected computers group” object, then these settings are applied across all the computer entities in the group that contain the protected computer group. The option to change the protected computer group properties is disabled at the level of the computer entity, so these settings can only be changed at the group level via the master computer entity.

Change “appliance maintenance” properties—if any of the “scheduled back-up job throttling”, “retention job schedule”, “integrity job schedule”, “daily email status report” or “weekly email status report” settings are changed from the options in the group level “appliance maintenance branch, then these settings are applied across all the computer entities in the group. It is also possible to change these appliance maintenance properties at the level of the individual computer entity, within the group, but any change at the appliance group level will propagate down to the computer entity level, and override any settings at the computer entity level (except for changes to the email status report settings which are not propagated).

Change “protected computer” properties—if any of the “schedule”, “retention”, “excludes”, “rights”, “limits and quotas”, “data file definition”, or “log critical file” settings are changed from the properties menu of the group level protected computers contained object, then these settings are applies across all the computer entities in the group. Note that the option to change protected computer container properties is disabled at the level of the computer entity, so these settings can only be changed at the group level via the MMC administration console.

The group level protected computers and users lists are real time views of the merged set of protected computers and users from all the computer entities in the group, so if one computer entity is offline, then it's protected computer accounts will not be shown in the group level view until the computer entity is online again. If any changes are made to the properties of a specific account in the group level protected computers list, then these changes are immediately applied on the computer entity that holds that account.

Since the master computer entity holds a full set of protective computer groups across the entire computer entity group, then all the groups will always be visible in the group level protective computers list. Of course, this list will be empty unless the computers which hold the computer accounts for those computer groups are online. Since the protected computer groups are synchronized across the group, then the full set of protected computer groups is also visible at the level of the computer entities, though they will be empty unless a particular computer entity holds accounts which are contained in the group. The group level protected computer list can be used to manage groups as with a stand alone computer entity. The ability to add computer group or delete a protected computer group is also disabled at the level of the computer entity, so these functions can only be performed at the group level.

Using the protected computer list at the group level a computer account can be added to a protected computer group via a drag and drop menu option. The protective computer account automatically updates its settings to match the schedule, retention, excludes, data file definition and limits and quotas properties of the protected computer group to which it has just been moved into.

The “add computer group” menu option can be used from the group level protected computers list to create a new computer group. This new computer group is created on the master appliance, and is then automatically synchronized across all the slave appliances.

The “delete menu” option can be used from the group level protected computers list to delete a new computer group. However, this menu option is only enabled when all of the computers which hold accounts that are in the computer group are online. When a computer group is successfully deleted from the group level protected computers list, then this deletion is synchronized across all slave computer entities in the group.

When any change is made to the following configuration settings on the master computer entity, the master computer updates its data management application configuration settings data with these new settings, and then sends this data back to the aggregation APIs, so that the slave computers are kept in synchronization with the master. Configuration settings synchronized include:

Group level global (protected computer container) properties: schedule, retention, excludes, writes, limits and quotas, data file definition and log critical files.

Protected computer groups and their properties: schedule, retention, excludes, writes, log critical files, data file definition and limits and quotas.

Appliance maintenance properties: scheduled back-up job throttling, retention job schedule, integrity job schedule, daily email status report, or weekly email status report.

The framework management application 702 automatically synchronizes this data across all the computer entities in the group. Where slave computer entity receive an updated version of the data management application configuration settings, then it should compare then with its current settings and automatically apply any differences. If, during a slaves synchronization, any of the group level protected computer container or protected computer group properties are changed, then these changes are propagated down to any lower levels.

Group level email status report settings require special handling. If daily email status report or weekly email status report settings are configured or used from a group level appliance maintenance object, then this schedules group level status reports generated by the master computer entity, which include the requested status information from all of the appliances in the group which were online at the time the group level status report was scheduled to be generated. If the daily email status report and weekly email status report appliance jobs are configured at the appliance level, then these are additional to any configured group level email reports. This means that the scheduled email status report property settings for daily or weekly job schedules and daily or weekly report configuration are not propagated down from the group level to the appliance level when the group level settings are changed. So if a slave computer entity receives notification via the aggregation APIs of group level settings change, then it should ignore the group level weekly email status report and daily email status report settings.

This means that if the master computer entity is offline for any reason, then it is not possible to perform any administration actions in the MMC console for that computer entity group. However, the web interface is on each of the slave computer entities in the group may be still available.

The master computer entity needs to provide settings to the aggregation service 607, as the data management application configuration settings that will then be synchronized across all computer entities in the group.

In step 1100, a first type of data management application configuration setting comprising global maintenance properties, is synchronized across all computer entities in the group. The global maintenance properties includes properties such as scheduled back up job throttling; and appliance maintenance job schedules. These are applied across all computer entities in the group by the aggregation service 607, with the data being input from the master management application 606.

In step 1101, a second type of data management application configuration settings comprising protected computer container properties, are synchronized across all computer entities in the group. The protected computer container properties include items such as schedules; retention; excludes; rights; limits and quotas; log critical files; and data file definitions. Again, this is effected by the master management application 606 supplying the protected computer container properties to the aggregation service 607, which then distributes them to the computer entities within the group, which then self apply those settings to themselves.

In step 1102, a third type of data management application configuration settings, are applied such that any protected computer groups and their properties are synchronized across the group. The properties synchronized to the protected computer groups includes schedule; retention; excludes; rights; limits and quotas; log critical files, and data file definitions applicable to protected computer groups. Again, this is effected by the master management application 606 applying those properties through the aggregation service 607 which sends data describing those properties to each of the computer entities within the group, which then self apply those properties to themselves.

An advantage of the above implementation is that it is quick and easy to add a new computer entity into a group of computer entities. The only synchronization between computer entities required is of group level configuration settings. There is no need for a distributed database merge operation, and there is no need to merge a new computer entities file systems into a distributed network file system shared across all computer entities.

Error checking is performed to ensure that a newly added computer entity can synchronize to the group level configuration settings.

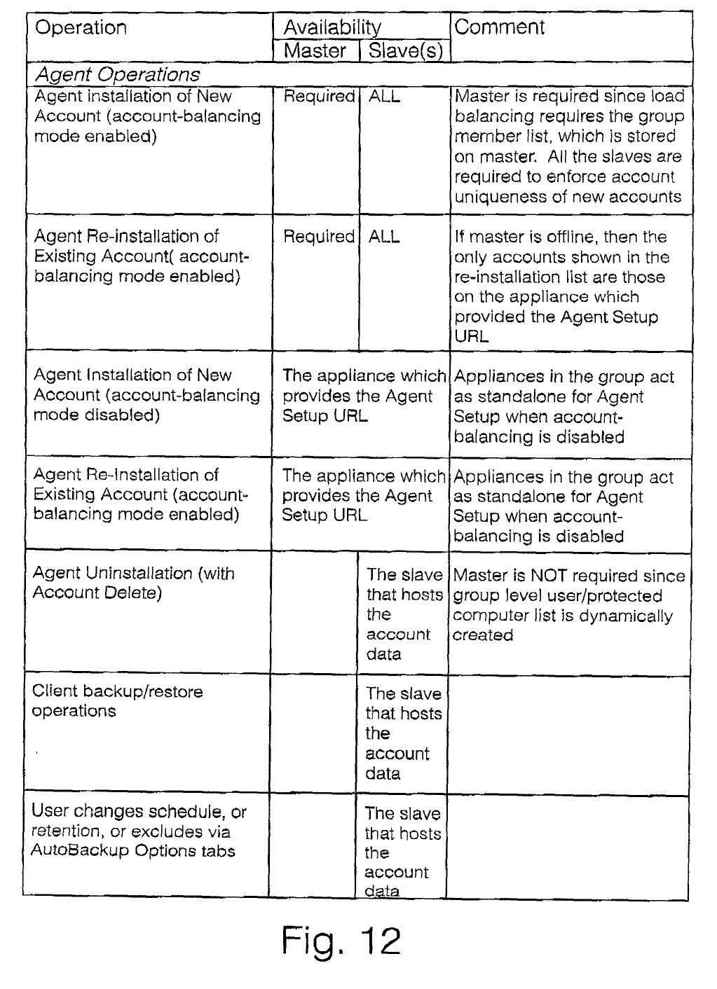

Referring to FIG. 12 herein, there is listed a set of operations which are carried out automatically by an agent.

Some of the operations require the master computer entity to be online in order to proceed.

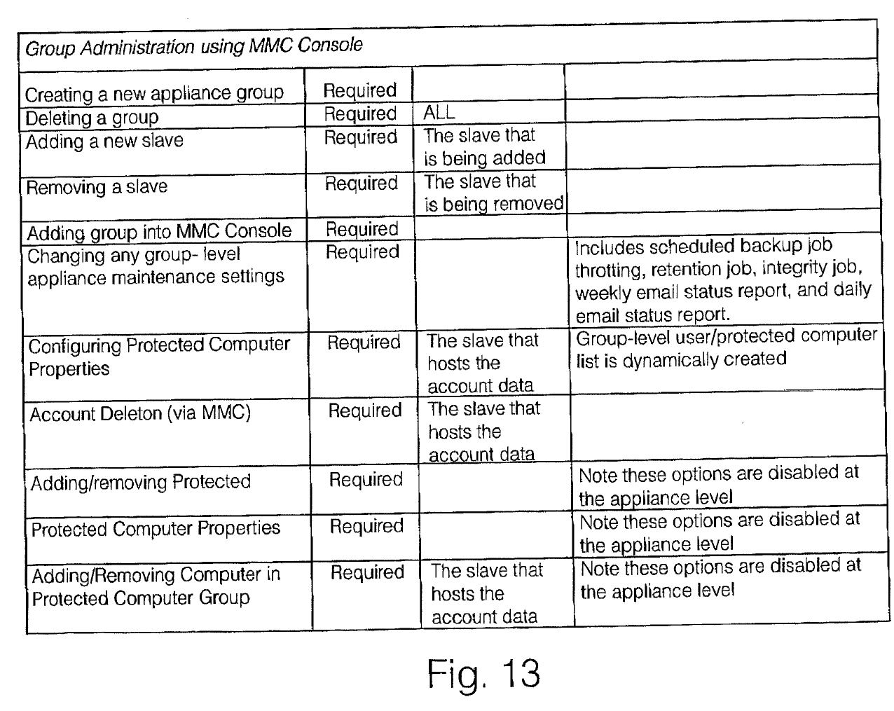

Referring to FIG. 13 herein, there are listed operations which are carried out at a group administration level using the management console computer.

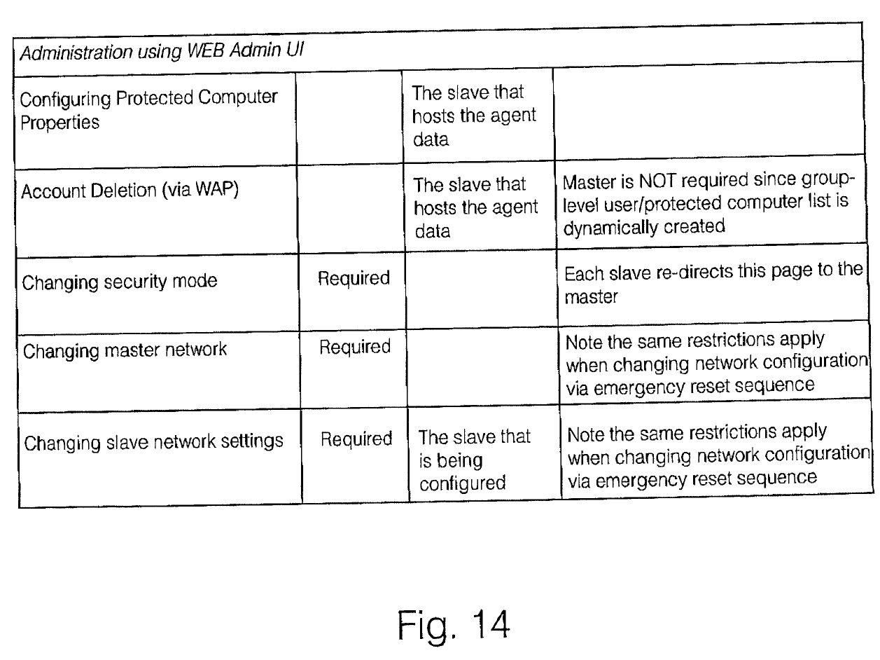

Referring to FIG. 14 herein, there are listed operations which can be carried out by an administrator using the web administration user interface.

There will now be described a method of agent installation.

An executable program is run to install an agent on a client computer entity. The agent can be received by downloading via the local web interface on the client computer entity, or can be received over the network from a master computer entity. The agent contains the IP address of the master computer entity. The agent is set up to always refer back to the master computer entity within the group.

The agent is created by an administrator using the MMC administration console, and an agent set-up utility available through that console. The agent is set-up on a computer entity selected from a list contained one the master computer entity within a group. When the agent installs on a slave computer entity, it will be automatically installed within a subgroup, and therefore will automatically pick up the policy settings of that subgroup. This requires that the master computer entity maintains a complete list of all subgroup settings for all subgroups within a group, that is, keeps a list of which subgroups exist, and what the policy settings are for each of those subgroups, and the master computer entity synchronizes those subgroup policies across all slave computer entities within a group.

Therefore, for example once a computer entity is designated as a slave, it is no longer to perform subgroup management directly on that computer, any subgroup management has to be done via the master computer entity in that subgroup. That is, one cannot access the slaved computer entity via the web interface on that slave directly, any access must be through the master computer entity. The web administration interface effectively switches off some of the functionality at the level of the individual slave computer, and control can only be effected via the master computer entity for that grouped slave.

When a group is created on the master, all application configuration settings on the master are replicated to all the slave computers. Therefore, an agent can be installed on any one of the computer entities within a group, because the application configuration settings are all synchronized for each application on each computer entity throughout the group.

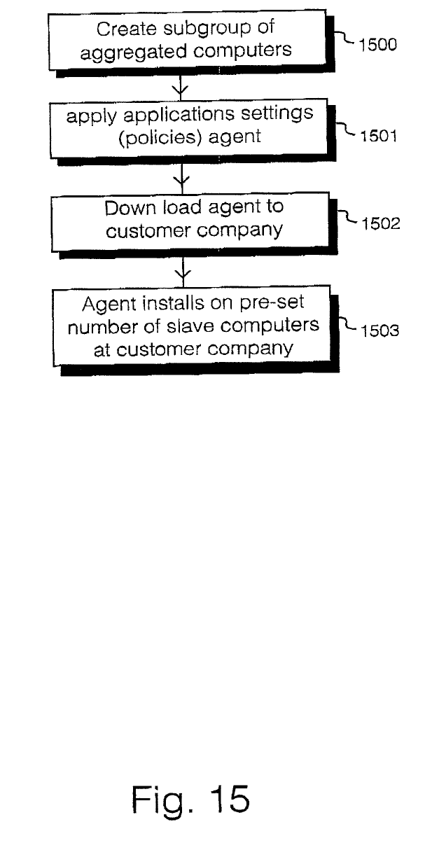

Referring to FIG. 15 herein, one way of using the systems disclosed herein, which may be beneficial to an external service provider, may be as follows:

Suppose the computer entity group is scaled up so that, for example, there are one million users of the computer entity group, the subgroup concept can be used to provide functionality for all a customers client computer entities, where the subgroup is tailored to the policies applied throughout all that companies computer entities.

For example, suppose a client company requires five thousand users, an operator of a computer group system may create a subgroup for that company, supplying five thousand users, with that companies particular policy settings applied across all slave computer entities within the subgroup (step 1500). The operator then gives the company an agent download (step 1502). When the company installs the agent onto all of their computers in step 1503, they automatically pick all that companies policy settings from the agent, the companies client computers are automatically capacity balanced across the slave computer entities in the subgroup operated by the operator, and the administrator in the external service provider has very little administration to do.

The administrator in the external service provider merely has to create a protective computer subgroup for the client company, create an agent download from that policy, and send the agent off to the client company to be loaded on the client computers.

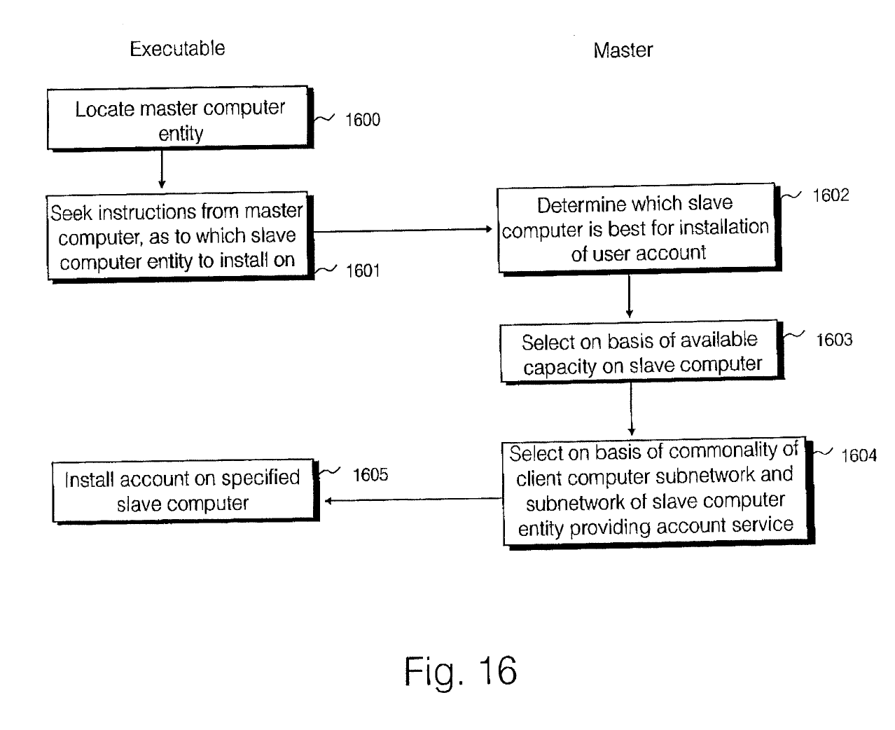

Referring to FIG. 16 herein, there is illustrated schematically process steps carried out by the executable agent installation program and the master computer entity for initiating installation of an agent onto a slave computer entity. In process 1600, the executable, having been received by a computer entity within a network, locates the master computer entity on the network. In step 1501, the executable seeks instructions from the master computer entity as to which slave computer entity to install the agent on. In step 1602, the master entity queries all slave computer entities within the group, and determines which slave computer is best for installation of a new user account. Determination is based upon the parameters of firstly data storage capacity of the slave computer entity, and secondly a sub-net mask of each of the slave compute entities. A local area network can be logically divided into a plurality of logical sub-networks. Each sub-network has its own range of addresses. Different sub-networks within the network are connected together by a router. The master computer entity attempts to match the sub-net on which a client computer for which an account is to be opened, with a slave back-up computer which is to provide that account, so that the slave back-up computer and the client computer are both on the same sub-network, thereby avoiding having to pass data through a router between different sub-networks to provide the user account back-up service. Following step 1604, the master computer sends the identification of the slave computer on which the new user account is to be installed, and the executable proceeds to install the new user account on that specified slave computer.

There will now be described details of user account balancing methods according to the best mode for carrying out the invention.

When the “account balancing” mode is enabled when the computer entity group is created, then the ability to aggregate multiple computer entities into a single logical group is also used to simplify an agent set up process, so that an administrator does not have to aggregate individual protected computer entities. With an aggregated computer entity group with the “account balancing” mode enabled, the administrator only has to provide one agent set up URL or agent download from any one of the computer entities in the group, and the agent set up process will automatically transparently redirect the account to the most suitable computer entity in the group based upon the available data storage capacities of individual computer entities within the group. The same scheme is also used for reinstalling an agent.

If the “account balancing” mode was disabled when the computer entity group was created, then each computer entity in the group acts as a stand-alone computer entity with respect to installing and reinstalling of agents. For creating new accounts, an account is created on a computer entity on which agent set-up was run, and any uniqueness checks are only run on that computer entity. When reinstalling an existing account, a reinstallation account list will only show the accounts held on the computer entity used to run an agent set-up web wizard.

When a user runs an agent set up to create a new account and the computer entity is part of an aggregated computer entity group with the account balancing mode enabled, then the following changes need to be made to the agent installation process:

If the computer entity group is in a “generic” security mode, then the agent set up web wizard should check that the new account being created by the user is unique across the entire computer entity group. This means that all the computer entities in the group must be on-line if the user tries to create a new account, and if any computer entity in the group is off-line then the user should get an error message in the agent set up wizard telling them this. If the new account is unique across the group, then the user downloads an AgentSetup.exe file, and runs this on their client computer.

Agent set up is performed by an agent set up executable program AgentSetup.exe.

If the appliance group is in the “NT domain” security mode, then the account uniqueness check across the entire appliance group is performed when AgentSetup.exe is run on the client. This is run before the account balancing algorithm is performed.

When an agent set up executable program (AgentSetup.exe) runs, it will perform an account balancing algorithm which is used to ensure that new accounts are evenly distributed across all computer entities in a group. This algorithm is based on current available free space on the computer entities in the group, plus a sub-net mask of the client running AgentSetup.exe.

All of the computer entities in the aggregated group need to be on-line in order to create a new account, because the account uniqueness check run by the AgentSetup.exe must be run across all the accounts in the entire appliance group. If one or more appliances in the group are off-line, then an error message should be displayed by AgentSetup.exe telling the user that they cannot create their new back-up account.

Computer entities are identified in the group which are valid targets to hold new client accounts. Any computer entities which have full data storage space, or have reached a “new user capacity limit” are excluded from the rest of the account balancing algorithm. If none of the computer entities in the group can create a new account, then an error message is displayed by the AgentSetup.exe executable telling the user this.

It is possible for computer entities within a group to have different sub-net settings. This is used for sites where there are multiple sub-nets and the computer entities within the group are configured on different sub-nets so that the backup traffic is kept within the sub-nets. Given this, the account balancing algorithm needs to attempt to create the new account on a computer entity in the group which matches the client's sub-net mask. The algorithm to select which computer entity in the group should hold the new account restricts itself to just those computer entities which are valid targets and which have the same sub-net mask as the client. If there are no computer entities within the group which are valid targets, and which match the client's sub-net mask, then the algorithm selects any valid appliance target in the group to hold the new account, regardless of sub-net masks.

From the set of valid computer entity targets which match the clients sub-net mask, or all valid computer entity targets if there is no match, the algorithm selects a computer entity with the maximum available free data storage space compared with the other valid computer entities. If there are multiple computer entities with the same maximum available free space, then the algorithm randomly selects one of these. The agent set up procedure is then automatically and transparently redirected to the selected computer entity. After redirection, the agent set up runs to completion as normal, targeting the selected computer entity.

When a user runs agent set up to reinstall an existing account and a computer entity is part of an aggregated group with account balancing mode enabled, then the following changes need to be made to the agent reinstallation process:

The account selection list shown during reinstallation of an existing account should be a super set of the existing accounts on all the computer entities in the group. If the selected account is on a different computer entity in the group, then AgentSet.exe up will automatically and transparently be redirected to continue the agent set up wizard on that computer entity. This therefore requires the master computer entity in the group to be online in order to provide a list of group members, and thus query all the computer entities in the group for the list of current accounts. If any slave computer entities are off line when the master runs the query, then any accounts held in the off line slave computer entities will not be displayed in the reinstallation account list. However, if the master computer entity is off line and the agent set up is run from one of the slave computer entities, then only the accounts held on that slave computer entity will be displayed.

The entire accounts selection list, in the best mode of implementation, is generated and ready for use within 10 seconds, for up to 5,000 account lists on five 1,000-account aggregated computer entities. Account selection lists are obtained from each of the computer entities in parallel across the network, so each computer entity in the group has to provide a list of 1,000 accounts within a 10 second time frame.

The same changes are required when a distributable agent is used to install the agent instead of a web-based agent set up wizard. In this case, using a distributable agent in a generic security mode, the agent generates a new unique account name from the master computer entity in the aggregated group, when “account balancing” is enabled, and this therefore guarantees the uniqueness of the account name across the appliance group.

There will now be described use of aggregation for account balancing.

If a data management application uses the aggregation features of the aggregation service application 700, then if the management application is user or account centric, in the best mode an account balancing scheme is used across the computer entity group. The aim of this account balancing is to treat the computer entity group as a single logical entity when creating new data management application accounts, which means that an administrator does not have to allocate individual accounts to specific computer entities.

For example, when creating a new account, the data management application may obtain a current computer entity group structure using a read appliance group structure API, and then use this information to query each data management application on every computer entity in the group. The account can then be installed on the computer entity in the group which best meets the data management application criteria for a new account, for example the computer entity with the most free data storage capacity available.

If the data management application does implement account balancing, then the administration should have the option, when creating a computer entity group, to enable or disable this mode. It is possible to disable the account balancing mode for the cases where the administrator wanted to be able to create a computer entity group across multiple different geographic sites for the purposes of setting data management policies. However, in this case, the administrator would want to keep the accounts for one site on the computer entities on that site, due to the network traffic.

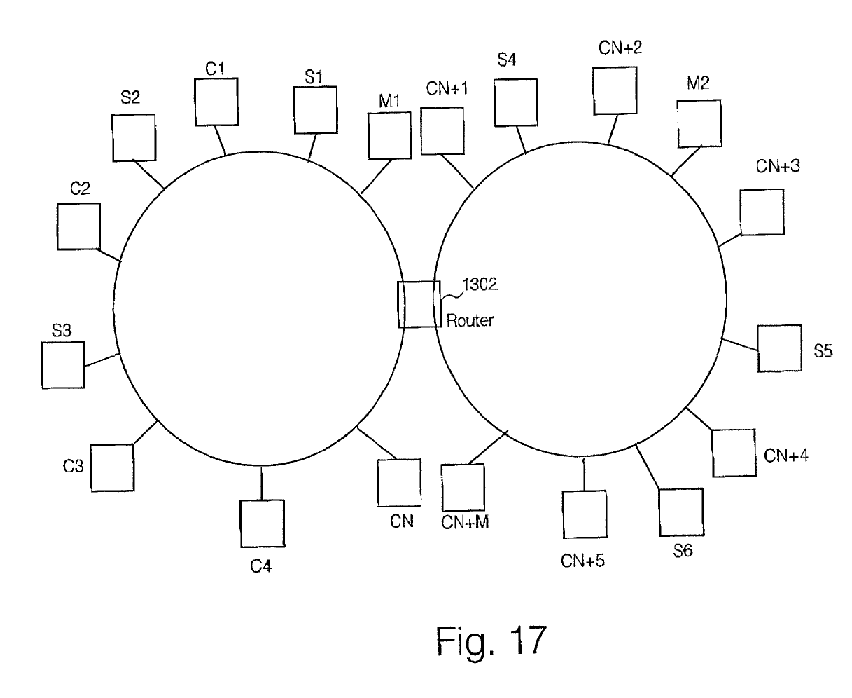

Referring to FIG. 17, there is illustrated schematically a network of a plurality of computer entities, comprising: a plurality of client computer entities C1-C_{N}, C_{N}+1: C_{N}+M, each client computer entity typically comprising a data processor, local data storage, memory, communications port, and user console having a visual display unit, keyboard and pointing device, e.g. mouse; a plurality of headless computer entities, the headless computer entities designated as master computer entities M1, M2, and slave computer entities, S1-S6. The master and slave computer entities provide a service to the client computers, for example a back-up facility. The master and slave headless computer entities may comprise for example network attached storage devices (NAS). The plurality of computer entities are deployed on the network across a plurality of sub-networks, in he example shown of first sub-network 1600 and a second sub-network 1601. The two sub-networks, comprising the complete network, are connected via a router 1602. The headless computer entities are aggregated into groups, comprising a master computer entity and at least one slave computer entity. In the best mode implementation, computer entity groups are all contained within a same sub-network, although in the general case, an aggregation group of headless computer entities may extend over two or more different sub-networks within a same network.

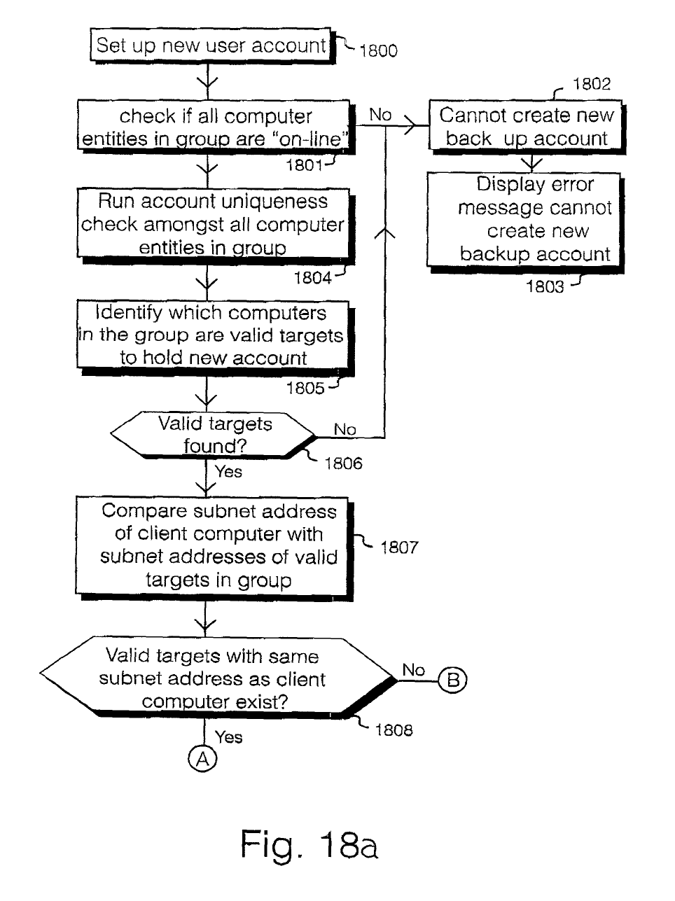

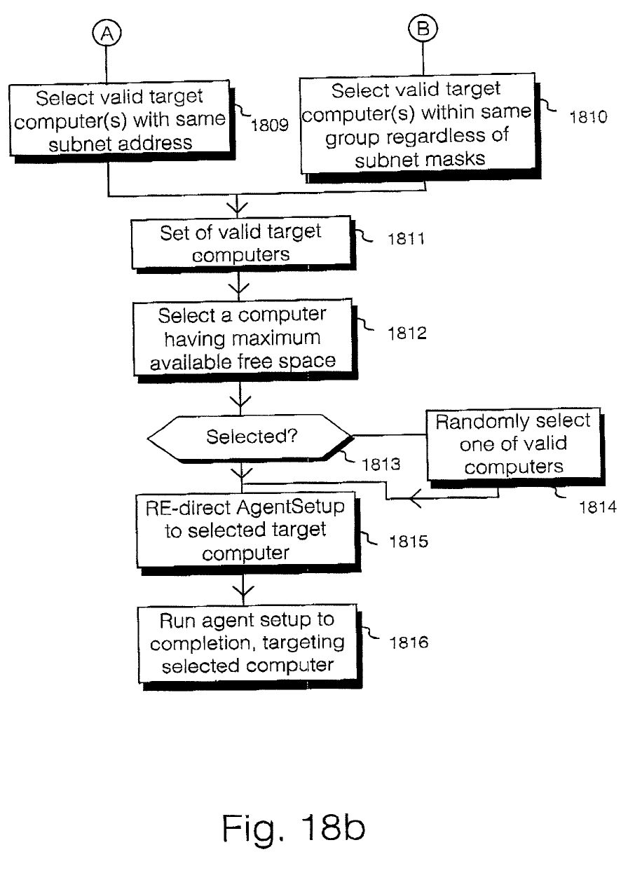

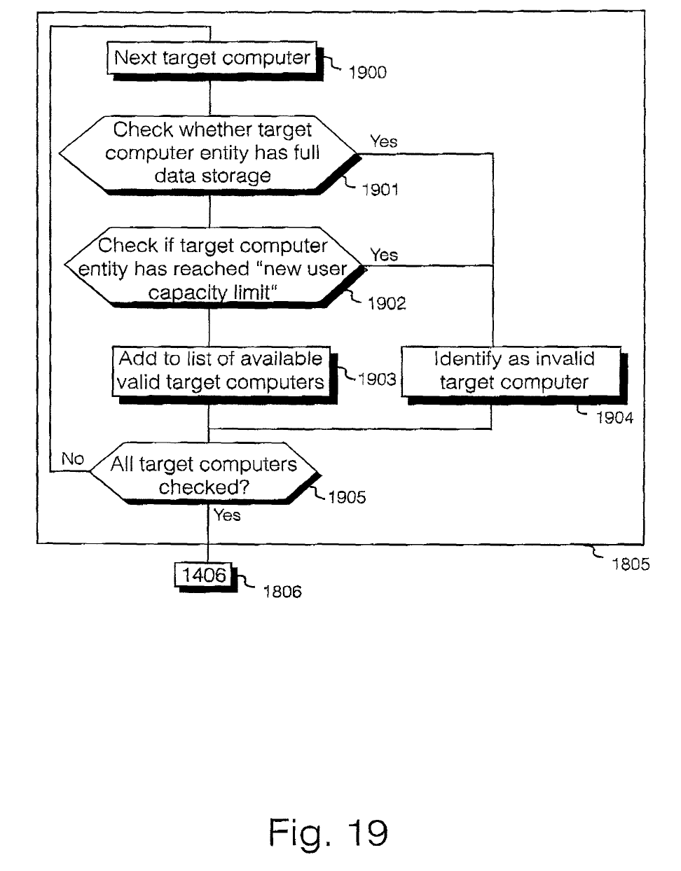

Referring to FIG. 18 herein, there is illustrated schematically process steps carried out by an account balancing algorithm for the process 1700 of setting up a new user account on a computer entity within an aggregated group. In step 1801, the algorithm checks that all computer entities within the group are on-line. If not, then in step 1802, the algorithm cannot create a new back-up account and in step 1803 displays an error message to a client computer that a new back-up account cannot be created. If however all computer entities within the group are on-line, then in step 1804 the algorithm runs an account uniqueness check amongst all the computer entities within the group. In step 1805, the algorithm identifies which computers in the group are valid targets to hold a new user account. If no valid targets are found in step 1806, then the algorithm cannot create a new back-up account and displays an error message in step 1803 as described in step 1803 previously. However, provided valid targets are found, then in step 1807 the algorithm compares a sub-net address of the client computer for whom the back-up account is to be created, with the sub-net addresses of all the valid targets found in the group. If valid targets computers are found with the same sub-net address as the client computer in step 1808, then in step 1809 the valid target computers having a same sub-net address as the client computer are selected to form a set of valid target computers 1811. However, if no valid target computers have a same sub-net address as the client computer to which a user account is to be supplied, then in step 1810, the algorithm selects a set of all valid target computers within the same group, regardless of the sub-net mask, to form a set of valid target computers 1811.

In step 1812, the algorithm selects a valid target computer having a maximum available free data storage space. If a computer entity having a maximum available free data storage space cannot be selected in step 1813, for example because two computers have a same amount of available free data storage space and no valid target computer has a maximum, then in step 1814 the algorithm randomly selects one of the valid target computers in the set 1811. In step 1815, the AgentSetup.exe is redirected to the selected target computer. In step 1816, the AgentSetup.exe program is run to completion, targeting the selected target computer, thereby creating one or more new accounts on that target computer for use by the client computer.

Referring to FIG. 18 herein, there is illustrated schematically one implementation of process steps carried out in step 1805 to identity which computers in a group are valid targets to hold a new user account. In step 1900, a next target computer within a group is identified by the algorithm. In step 1901, the algorithm checks whether the target computer has any available data storage space left. If the data storage space is full, then in step 1904 the algorithm identifies the computer as an invalid target computer. However, if the data storage space is not full, then in step 1902 the algorithm checks if the target computer entity has reached a “new user capacity limit”, being a limit at which new users cannot be taken onto that computer entity. If that limit is reached, then that computer is identified as an invalid target computer in step 1804. However, if the new user capacity limit has not been reached, then in step 1903, the computer is added to the list of available valid target computers. In step 1905, it is checked whether all possible target computers have been checked, and if not steps 1900-1905 are repeated until all target computers have been checked for validity.

The algorithm not only balances accounts across a plurality of grouped computers based upon individual capacity available at each grouped computer, but also takes into consideration network traffic, and attempts to minimize sending network traffic through routers, and keep the traffic within a same sub-network as the client computer from which it originates.

The best mode implementation described herein is account-centric. That is, to say that the system is designed around a plurality of individual user accounts distributed amongst a plurality of computer entities which are aggregated into groups, in which all computer entities within the group have common operating system configuration settings, and common application level settings applied across the group.

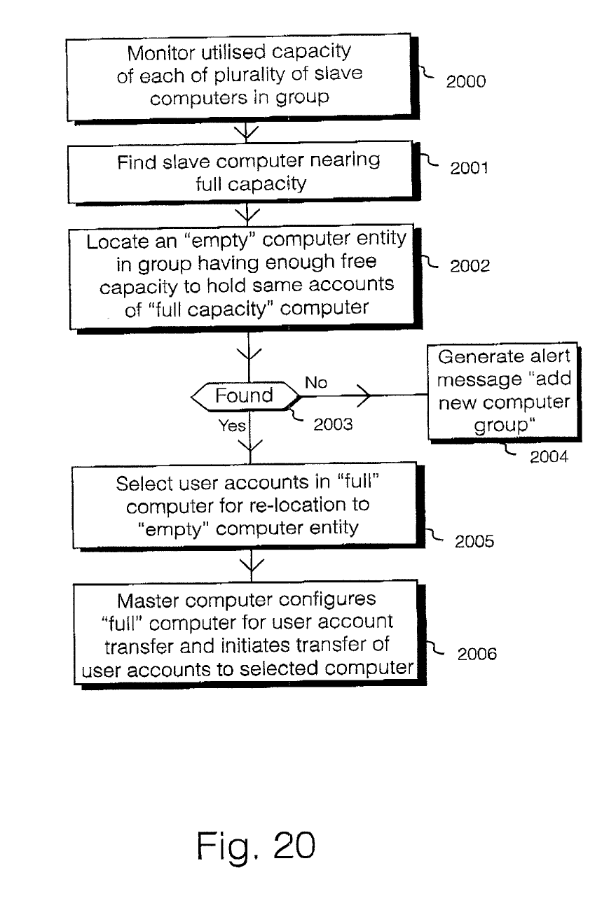

Referring to FIG. 20 herein, there is an illustrated schematically processes carried out by the management console MMC application 616 for automatic balancing of user accounts across the plurality of computers in a group. The MMC application 616 contains a user account migration component, which operates to move complete user accounts, eg. a clients backup account, from one computer entity within a group to another, without any impact on the user who owns that account.

Since each user account is stored on a single computer entity within the group, if the data storage space on that computer entity becomes fully utilised, then there is no further capacity on that computer entity for addition of further data in the user account. Therefore, the user accounts must be moved from the “full” computer entity onto an “empty” computer entity. The empty computer entity can be any computer entity within the group having enough spare storage capacity to accommodate a user account moved from the full computer entity. An empty computer entity may be a new computer entity added into the group, having un-utilised data storage capacity.

Whether a new computer entity is added to the group or not, the MMC application 616 is continuously monitoring all computer entities within the group, searching for computers which are approaching a full utilisaton of data storage capacity and seeking to relocate accounts on those full computer entities to other computer entities within the group having un-utilised data storage capacity. Where a full computer entity is found, then the MMC application locates an empty computer entity and then initiates a transfer of user account data from the full computer entity to the empty computer entity, thereby leveling the utilisation of capacity across all computer entities within a group.

Steps 2000-2006 can be set to operate continuously, or periodically, on the management console 617.

In step 2000, the MMC application monitors the utilised capacity on each of the plurality of computers in a group. The MMC application monitors the data storage capacity utilisation, and compares this with the hard and soft quota limits in each computer in the group. In step 2001, having found a computer entity where utilisation of data storage space is above the soft quota limit, this indicates that that computer entity is becoming “full”, ie. the data storage capacity is almost fully utilised. Therefore the MMC application continues in step 2002 to locate a “empty” computer entity within the group having enough free capacity to hold some accounts from the located full computer. The MMC console checks a “new user capacity limit” on each computer entity in the group, being a capacity limit for addition of a number of new users. If a suitable computer entity having a number of users below the new user capacity limit is not found in step 2003, then the MMC application 616 generates an alert message to the administrator to add a new computer to the group in step 2004. However, if the MMC application finds a suitable computer having a number of users below the new user capacity limit, then in step 2005, the MMC application selects user accounts from the full computer for relocation to the selected empty computer. Where more than one empty computer is found, the MMC application may select the empty computer randomly, or on the basis of lowest utilised capacity. In step 2006, once the master computer entity has determined which user accounts are to be transferred from the full computer to the selected empty computer or computers, to receive those user accounts, then the master computer configures and then initiates a user account migration job on the full computer. From this point, user account migration runs as though the administrator has manually configured a user account transfer using the MMC console. However, the process is initiated automatically without human administrator intervention. Therefore, even if all computers in the computer group are nearing full capacity a human administrator would only have to install a new empty slave computer into the group, and the automatic capacity leveling provided by the process of FIG. 20 would automatically start transferring accounts from full computers onto the newly added computer entity, so that capacity was freed up on the full computers in the group.

1. A computer system comprising:
a first plurality of client computer entities; and
a second plurality of computer entities connected logically into a group in which:
a said computer entity is designated as a master computer entity;
at least one of said computer entities is designated as a slave computer entity; and
said slave computer entity comprises an agent component for allocating functionality provided by said slave computer entity to one or more users operating said client computer entities served by said group of computer entities, wherein said agent component operates to automatically allocate said slave computer functionality by:
creating a plurality of user accounts, each said user account providing an amount of computing functionality to an authorised user;
selecting a said slave computer entity and allocating said user account to said slave computer entity; and
allocating to each said user account an amount of computing functionality provided by a said slave computer entity.

2. An account balancing method for selecting a server computer entity for installation of a new user account to supply functionality to a client computer entity, said method comprising the steps of:
identifying at least one said server computer entity capable of providing functionality to said client computer entity;
performing at least one test to check that said identified server computer entity is suitable for providing functionality to said client computer entity;
if said server computer entity is suitable for providing said functionality, then opening a user account with said selected server computer entity, said user account assigning said functionality to said client computer entity.

3. The method as claimed in claim 2, wherein said step of identifying at least one computer entity comprises:
running a uniqueness check amongst a plurality of said server computer entities aggregated in a group.

4. The method as claimed in claim 2, wherein said step of identifying at least one computer entity comprises:
identifying which of a plurality of computers in a group are valid computer entities to hold a new account.

5. The method as claimed in claim 2, wherein said step of identifying at least one computer entity comprises:
comparing a sub-network address of at least one server computer entity in a group with a sub-network address of a said client computer.

6. The method as claimed in claim 5, wherein:
if a server computer entity having a said sub-network address as a sub-network address of said client computer is not identified,
selecting any server computer entity within a group, regardless of its sub-network address.

7. The method as claimed in claim 2, comprising the step of:
selecting a server computer entity having a maximum available data storage space.

8. The algorithm as claimed in claim 2, further implementing the process of:
installing an agent onto a selected computer entity, said agent handling a said user account for said client computer entity.

9. A method of allocation of functionality provided by a plurality of grouped computer entities to a plurality of client computer entities, wherein each said client computer entity is provided with at least one account on one of said grouped computer entities, said method comprising the steps of:
determining a sub-network address of a client computer for which an account is to be provided by at least one said computer entity of said group;
selecting individual computer entities from said group, having a same sub-network address as said client computer: and
opening an account for said client computer on a said selected computer entity having a same sub-network address.

10. The method as claimed in claim 9, wherein said step of selecting a grouped computer entity further comprises the steps of:
selecting a said grouped computer entity on the basis of maximum available data storage space.

11. The method as claimed in claim 9, wherein said step of selecting said grouped computer entity comprises:
randomly selecting one of a set of said grouped computer entities having a same sub-network address as said client computer.

12. The method as claimed in claim 9, wherein said step of setting up an account on said selected grouped computer entity comprises:
directing an executable file to said selected grouped computer entity, said executable file operating to execute set up of a user account for said client computer on said selected grouped computer entity.

13. A plurality of computer entities configured into a group, said plurality of computer entities comprising:
at least one master computer entity controlling configuration of all computer entities within said group;
a plurality of slave computer entities, which have configuration settings controllable by said master computer entity;
an aggregation service application, said aggregation service application configured to receive application settings from at least one application program, and distribute said application configuration settings across all computer entities within said group for at least one application resident on said group.

14. The method as claimed in claim 13, wherein:
said master computer entity comprises a master application, said master application having a set of master application settings;
at least one slave application, resident on a corresponding slave computer entity,
wherein said slave application, is set by said set of master application configuration settings.

15. A method of configuring a plurality of applications programs deployed across a plurality of computer entities configured into a group of computer entities, such that all said application programs of the same type are sychronised to be configured with the same set of application program settings, said method comprising the steps of:
generating a master set of application configuration settings;
converting said set of master application configuration settings to a form which are transportable over a local area network connection connecting said group of computer entities;
receiving said master application configuration settings at a client computer of said group; and
applying said master application configuration settings to a client application resident on said client computer within said group.

16. The method as claimed in claim 15, wherein:
a said master application configuration setting comprising a setting selected from the set:
an international time setting;
a default data storage capacity setting;
an exclude setting;
a user rights settings;
a data file definition setting;
a schedule setting;
a quota setting;
a log critical file setting.

17. A computer system comprising;
a plurality of computer entities connected logically into a group in which:
a said computer entity is designated as a master computer entity;
at least one of said computer entities is designated as a slave computer entity; and
said master computer entity and said at least one slave computer entity each comprise a corresponding respective application program, wherein a common set of application configuration settings are applied to a master said application program on said master computer entity, and a slave said application program on said slave computer entity.

18. A computer device comprising:
at least one data processor;
at least one data storage device capable of storing an applications program;
an operating system;
a user application capable of synchronizing to a common set of application configuration settings;
an aggregation service application, capable of interfacing with said user application, for transmission of said user application configuration settings between said user application and said aggregation service application.

19. The computer device as claimed in claim 18, wherein said user application communicates said user application configuration settings with said aggregation service application via a set of API calls.

20. The computer device as claimed in claim 18, wherein said user application comprises a master user application, which sends a set of common application configuration settings to said aggregation service applications.

21. The computer device as claimed in claim 20, wherein said user application comprises a slave application, which receives a set of application configuration settings from said aggregation service application, and applies those application configuration settings to itself.

22. A method of aggregation of a plurality of computer entities, by deployment of an agent component, said agent component comprising:
a user application;
an aggregation service application;
said method comprising the steps of: loading a plurality of application configuration settings into said user application within said agent;
defining a sub-group of computer entities to be created by said agent and loading data defining said subgroup into said agent;
sending said agent component to a plurality of target computer entities of said plurality of computer entities;
within each said target computer entity, said agent installing said user application and said aggregation of service application, and deploying said application configuration settings within said target computer entity.

23. A method for transfer of user accounts between a plurality of computer entities within a group of said computer entities, said method comprising the steps of:
monitoring a utilisation of each of a set of said computer entities within said group to locate a computer entity having a capacity which is utilised at above a pre-determined limit;
searching for a computer entity within said set which has a capacity utilisation below a second pre-determined limit;
selecting at least 1 user account located on said computer entity having said utilised capacity above said first predetermined limit; and
transferring said at least one selected user account from said computer entity having capacity utilisation above said first pre-determined limit to said selected computer entity having utilisation below said second predetermined limit.

24. The method as claimed in claim 23, wherein said, computer having capacity utilised below said second pre-determined limit is selected on the basis of:
said second pre-determined limit comprising a new user capacity limit, designating a number of users which can be accommodated on said computer entities; and
an actual number of users located on said computer entity is below said new user capacity limit.

25. The method as claimed in claim 23, wherein, said step of finding said computer entity having capacity utilisation above a first pre-determined limit comprises;
monitoring a data storage capacity of each of said plurality of computer entities within said set;
for each said computer entity, comparing said capacity utilisation with a capacity quota limit, being a limit indicating said computer entity is approaching a maximum capacity utilisation.

26. The method as claimed in claim 23, wherein said step of selecting at least one user account for transfer comprises randomly selecting said user account.

27. The method as claimed in claim 23, where in said step of selecting a user account comprises:
selecting a user account having a largest data size on said computer entity on which said user account is resident.
